(19) United States
(12) Patent Application Publication
(10) Pub. No.: US 2026/0110586 A1
(43) Pub. Date: Apr. 23, 2026

(54) PIEZORESISTIVE PRESSURE SENSOR AND METHOD FOR MANUFACTURING SUCH A PIEZORESISTIVE PRESSURE SENSOR

(71) Applicant: Kistler Holding AG, Winterthur (CH)

(72) Inventors: Mathieu ROHNER, Zuerich (CH); Joerg GRAMICH, Illnau (CH)

(21) Appl. No.: 19/363,708

(22) Filed: Oct. 21, 2025

(30) Foreign Application Priority Data
Oct. 21, 2024 (EP) 24207817.8

(51) Int. Cl. G01L 9/00; G01L 1/18

(52) U.S. Cl. CPC G01L 9/0055; G01L 1/18; G01L 9/0047

(57) ABSTRACT

A piezoresistive pressure sensor for measuring the pressure of a medium in an environment includes a housing defining an interior, a base body disposed in the interior and connected to the housing and defining a diaphragm, and a measuring unit with a piezoresistive element disposed in the interior so as to detect a deflection of the diaphragm. The diaphragm confines a blind hole of the base body and an opening through the housing is arranged to communicate with the blind hole when the piezoresistive pressure sensor is exposed to the medium so as to deflect the diaphragm. A material bonding connection connects the base body directly to the housing in a mechanically tight manner while exhibiting a melting temperature greater than or equal to 250° C. An electrical conductor taps the piezoresistive element's change in resistance as electrical voltage and discharges the voltage into the environment.

### TECHNICAL FIELD

The invention relates to a piezoresistive pressure sensor and a method for manufacturing such a piezoresistive pressure sensor according to the preambles of the independent claims.

### BACKGROUND OF THE INVENTION

A pressure sensor is used to measure the pressure of a liquid or gaseous medium. The pressure measurement can be performed as an absolute pressure measurement with reference to a reference pressure or as a relative pressure measurement without such a reference. The pressure measurement can be done in a static manner over long periods of several months, for example when measuring the pressure in a motor vehicle tire, but it can also occur in a dynamic fashion in fractions of a second, such as in explosions in a motor vehicle combustion engine. In recent decades, a wide variety of pressure measurement principles have been developed, which is the reason why a distinction is made between piezoelectric, piezoresistive, optical, capacitive pressure sensors, etc.

Eventually, the present invention also relates to a piezoresistive pressure sensor as known from DE202009013919U1. The piezoresistive pressure sensor comprises a base body made of silicon or glass, in which a blind hole is introduced in one side. In the area of the blind hole, said base body forms a diaphragm. The medium directed through the blind hole to the diaphragm applies pressure to the diaphragm and deflects said diaphragm. On the side of the diaphragm facing away from the blind hole, a measuring unit comprising resistance elements made of piezoresistive material is arranged. Said measuring unit detects the deflection of the diaphragm as a change in resistance. A circuit unit, which is also located on the base body, converts the change in resistance into a measuring signal.

By arranging the measuring unit and the circuit unit on the side of the diaphragm facing away from the blind hole, said measuring unit and said circuit unit are not directly exposed to the medium, so that the piezoresistive pressure sensor is also suitable for measuring the pressure of a chemically aggressive medium such as fuel for combustion engines without the fuel being able to corrode the measuring unit and the circuit unit, which would undesirably impair the availability of the piezoresistive pressure sensor.

In order to protect said measuring unit and said circuit unit from harmful environmental influences such as moisture, dust, contact, etc., and also to mount said piezoresistive pressure sensor at a measuring point, the piezoresistive pressure sensor comprises a housing. The housing of the DE202009013919U1 exhibits a hollow cylindrical form and is made of metal. The base body with the measuring unit and circuit unit arranged on it is fastened in an interior of the housing via a carrier, which is also made of metal. Thus said base body is fastened to the carrier via a glass solder or adhesive connection, and said carrier in turn is welded to the housing in the interior in a pressure-tight manner. Said base body is arranged in the interior in such a way that the medium can only reach the blind hole in the base body via an opening on the front side of the housing and via a through-hole in the carrier. The piezoresistive pressure sensor can be mounted at the measuring point via an external thread on the housing side.

The circuit unit of DE202009013919U1 comprises an integrated circuit and electronic components which are often only designed for continuous operating temperatures in the range of from −55° C. to 125° C. For continuous operating temperatures of the piezoresistive pressure sensor exceeding 200° C., special designs of the integrated circuit and the electronic components are therefore necessary. Such special designs of the integrated circuit and the electronic components are only manufactured in small quantities, which makes their acquisition complex and expensive.

Furthermore, said integrated circuit and said measuring unit of DE202009013919U1 are manufactured on a carrier made of silicon. Silicon is a semiconductor and exhibits high leakage currents at continuous operating temperatures of said piezoresistive pressure sensor exceeding 200° C., which can distort the measurement signal and thus significantly impair the accuracy of the pressure measurement.

Said circuit unit and said measuring unit are also cast with a casting compound on the side of the diaphragm facing away from the blind hole of DE202009013919U1 to protect said integrated circuit, said electronic components, and said electrical connections to the measuring unit against mechanical shocks and vibrations. Said casting compound is usually made of plastic material such as polyurethane, epoxy resin, silicone, etc., and begins to decompose at continuous operating temperatures of the piezoresistive pressure sensor exceeding 200° C. The missing protective compound can no longer provide protection against mechanical shocks and vibrations, which undesirably shortens the service life of the piezoresistive pressure sensor. The decomposed casting compound can undesirably reduce the functionality of the piezoresistive pressure sensor.

In addition, in the piezoresistive pressure sensor of DE202009013919U1, said base body made of silicon or glass, said glass solder joint, and said metal carrier exhibit different thermal expansion coefficients. At continuous operating temperatures of the piezoresistive pressure sensor exceeding 200° C., mechanical stresses occur that can lead to cracks or fractures in the base body or in the glass solder joint, which increases the probability of failure of the piezoresistive pressure sensor.

Finally, at continuous operating temperatures of more than 200° C., the adhesive bond of DE202009013919U1 may begin to creep and even break. This, in turn, can impair the fastening of the base body inside the housing and cause premature failure of the piezoresistive pressure sensor.

### OBJECTS AND SUMMARY OF THE INVENTION

Thus, there is potential for improvement.

It is an object of the present invention to improve the piezoresistive pressure sensor of DE202009013919U1. The invention also aims to disclose a method for manufacturing a piezoresistive pressure sensor which is improved over that of the piezoresistive pressure sensor of DE202009013919U1.

These objects are solved by the features described herein.

The invention relates to a piezoresistive pressure sensor for measuring the pressure of a medium in an environment; comprising at least one housing, at least one base body, and at least one measuring unit; which housing comprises an interior and an opening; which base body and which measuring unit are arranged in the interior; in which base body a blind hole and a diaphragm are formed, which diaphragm confines said blind hole on one side; which base body is arranged in the interior in such a way that said blind hole communicates with the opening; which piezoresistive pressure sensor is designed, when it is exposed to the medium, to allow the medium to penetrate through the opening and the blind hole to the diaphragm, which pressure of the medium that has penetrated to the diaphragm deflects the diaphragm; which measuring unit is arranged on a side of the diaphragm facing away from the blind hole and generates a change in resistance for the deflection of the diaphragm, which change in resistance is proportional to the pressure to be measured; wherein said piezoresistive pressure sensor comprises at least one material bonding connection, which material bonding connection connects the base body directly to the housing in a mechanically tight manner; and wherein the material bonding connection exhibits a melting temperature greater than or equal to 250° C.

The invention also relates to a method for manufacturing a piezoresistive pressure sensor for measuring the pressure of a medium in an environment; comprising at least one housing, at least one base body, and at least one measuring unit; which housing comprises an interior and an opening; which base body and measuring unit are arranged in the interior; in which base body a blind hole and a diaphragm are formed, which diaphragm confines the blind hole on one side; which base body is arranged in the interior in such a way that the blind hole communicates with said opening; which piezoresistive pressure sensor, when it is exposed to the medium, is designed to allow the medium to penetrate through the opening and the blind hole to the diaphragm, which pressure of the medium that has penetrated to the diaphragm deflects the diaphragm; which measuring unit is arranged on a side of the diaphragm facing away from the blind hole and generates a change in resistance for the deflection of the diaphragm, which change in resistance is proportional to the pressure to be measured; wherein, in a first step of the method, said housing and said base body are provided; and wherein, in further steps of the method, the base body is connected directly to the housing via at least one material bonding connection in a mechanically tight manner, which material bonding connection exhibits a melting temperature greater than or equal to 250° C.

In a first difference to the piezoresistive pressure sensor of DE202009013919U1, said piezoresistive pressure sensor according to the invention does not require a carrier made of metal. Instead, said base body is directly connected to the housing in a material-bonding manner. The omission of said metal carrier simplifies and improves the design of the piezoresistive pressure sensor in an economic manner.

In a further difference to said piezoresistive pressure sensor of DE202009013919U1, the invention provides a material bonding connection with a melting temperature greater than or equal to 250° C. for the mechanically tight connection of the base body to the housing. This prevents creep or breakage of the glass solder or adhesive connection of DE202009013919U1, which reduces the probability of failure of the piezoresistive pressure sensor.

Advantageous embodiments of the invention are described in detail herein.

Thus, the piezoresistive pressure sensor comprises at least one electrical conductor, which electrical conductor taps the change in resistance as an electrical voltage and discharges it into the environment.

Accordingly, in a further step of the method, at least one electrical conductor is provided; and wherein in a further step of the method, said electrical conductor is electrically connected to the measuring unit, which electrical conductor taps the change in resistance as an electrical voltage and discharges it into the environment.

In yet another difference to the piezoresistive pressure sensor of DE202009013919U1, said piezoresistive pressure sensor according to the invention does not comprise a circuit unit in the housing that converts the change in resistance into a measurement signal. Instead, the change in resistance is conducted to the environment as an electrical voltage via an electrical conductor. The absence of the circuit unit in the housing simplifies the design of said piezoresistive pressure sensor. And since the integrated circuit and the electronic components of the circuit unit are often only designed for continuous operating temperatures up to 125° C. and large leakage currents occur in integrated circuits with a carrier made of silicon, the operating range of said piezoresistive pressure sensor is thus improved, since continuous operating temperatures of more than 200° C. are now possible.

In an additional difference to the piezoresistive pressure sensor of DE202009013919U1, the piezoresistive pressure sensor according to the invention does not comprise a casting compound to protect the integrated circuit and the electronic components of the circuit unit, as well as to protect said measuring unit, which casting compound decomposes at continuous operating temperatures of the piezoresistive pressure sensor of more than 200° C. and thus can no longer fulfill its protective function, while the decomposed casting compound can impair the functionality of the piezoresistive pressure sensor.

### BRIEF DESCRIPTION OF THE DRAWINGS

In the following, the invention will be explained in more detail in exemplary embodiments with reference to figures.

FIG. 1 shows a longitudinal section through a part of a first embodiment of a piezoresistive pressure sensor 10 with a one-component housing 1;

FIG. 2 shows a longitudinal section through a part of a second embodiment of a piezoresistive pressure sensor 10 with a multi-component housing 1;

FIG. 3 shows a cross-section of a part of the piezoresistive pressure sensor 10 according to FIG. 1 or 2 along a section pathway A-A;

FIG. 4 shows a flow chart comprising steps MI to MVI in the method for manufacturing the piezoresistive pressure sensor 10 according to FIG. 1 or 2 in a variant using a material bonding connection 4 in embodiments of a soldered joint; and

FIG. 5 shows a flow chart comprising steps MI to MVI in the method for manufacturing the piezoresistive pressure sensor 10 according to FIG. 1 or 2 in a variant using a material bonding connection 4 in the form of a glass solder.

Identical reference numerals denote identical objects in the figures.

### DETAILED DESCRIPTION OF EXEMPLARY EMBODIMENTS OF THE INVENTION

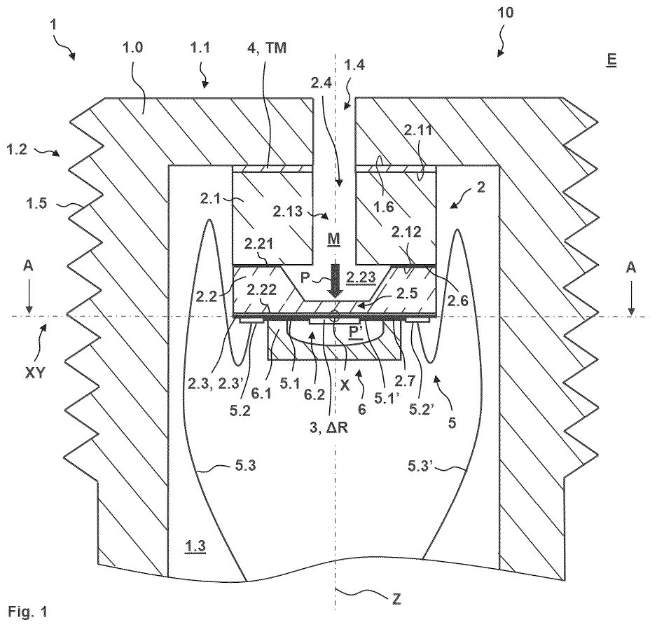

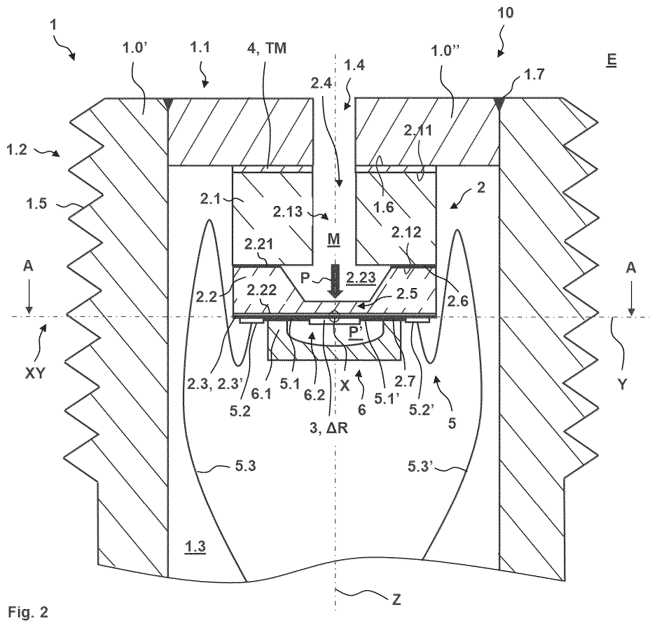

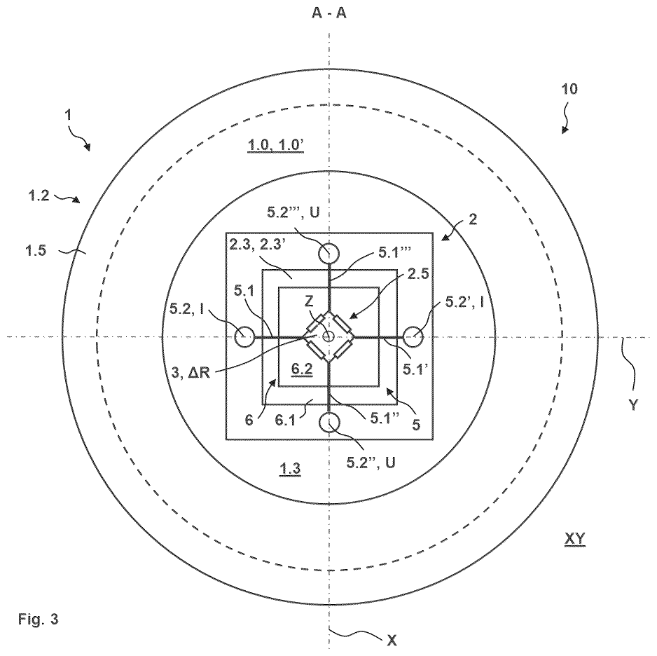

FIGS. 1 and 2 show a longitudinal section through a part of the piezoresistive pressure sensor 10 along a vertical axis Z. FIG. 3 shows the piezoresistive pressure sensor 10 along a section pathway A-A in a cross-section of a horizontal plane XY spanned by a horizontal axis X and a longitudinal axis Y. The three axes X, Y, Z are perpendicular to each other.

The piezoresistive pressure sensor 10 is designed for continuous operating temperatures of up to 450° C.

Said piezoresistive pressure sensor 10 comprises at least one housing 1, at least one base body 2, and at least one measuring unit 3.

### Housing 1

On the one hand, said housing 1 has the function of protecting the measuring unit 3 against harmful environmental influences such as moisture, dust, contact, etc. On the other hand, said housing 1 has the function of enabling the piezoresistive pressure sensor 10 to be mounted at a measuring point.

Said housing 1 comprises at least one front face 1.1, at least one lateral surface 1.2, and an interior 1.3. The front face 1.1 and the lateral surface 1.2 completely enclose the interior 1.3. The front face 1.1 and the lateral surface 1.2 confine said housing 1 against an environment E. The environment E is located outside the housing 1. Said housing 1 separates the interior 1.3 from the environment E. The measuring unit 3 is arranged in the interior 1.3. Harmful environmental influences from the environment E cannot enter the interior 1.3 through the housing 1.

A medium M is located in environment E. Medium M can be any liquid or gaseous medium. Medium M exhibits a pressure P in the range of from 1 bar to 250 bar.

At least one opening 1.4 is provided on the front face 1.1, which extends from the environment E to the interior 1.3 and thus the housing 1 is configured to expose the opening 1.4 to the environment. The function of said opening 1.4 is to direct the medium M to the measuring unit 3 in a targeted manner.

According to FIG. 1, said opening 1.4 extends along the vertical axis Z. In a plane perpendicular to the vertical axis Z, the opening 1.4 has a diameter. The smallest diameter of the opening 1.4 is less than or equal to 1000 μm, preferably less than or equal to 500 μm.

On the side of the housing 1 facing away from said front face 1.1 and towards interior 1.3, said housing 1 forms an end face 1.6 in the area of the opening 1.4.

According to FIG. 1, said end face 1.6 extends in a plane perpendicular to the vertical axis Z around the opening 1.4. Said end face 1.6 completely encloses the opening 1.4.

At least one mounting means 1.5 is attached to the lateral surface 1.2. Preferably, said mounting means 1.5 is an external thread. The piezoresistive pressure sensor 10 can be mounted at a measuring point in the environment E via said external thread. For this purpose, said measuring point comprises an internal thread that matches the external thread. The measuring point and the internal thread are not shown in the figure.

The housing 1 can be manufactured in one component or in multiple components. For this purpose, said housing 1 comprises at least one housing body 1.0, 1.0′, 1.0″.

In the embodiment according to FIG. 1, said housing 1 is manufactured in one component and comprises a single housing body 1.0. Preferably, housing body 1.0 exhibits a hollow cylindrical form and comprises the front face 1.1 and the lateral surface 1.2.

In the embodiment according to FIG. 2, said housing 1 is manufactured in multiple components and comprises a first housing body 1.0′and at least one second housing body 1.0″. Preferably, the first housing body 1.0′ exhibits a hollow cylindrical form and generates the lateral surface 1.2 defining the exterior cylindrical surface elongating in the direction of the Z-axis of the first housing body 1.0'. Preferably, the second housing body 1.0″ is disc-shaped and forms the front face 1.1 defining the exterior surface of the second housing body 1.0″. The first housing body 1.0′ and the second housing body 1.0″ are connected to each other via a material bonding connection 1.7. Preferably, the material bonding connection 1.7 is an annular welded connection which extends over 360° around the entire circumference of the front face 1.1. Said material bonding connection 1.7 is pressure-tight, which means that the medium M located in the environment E cannot enter the interior 1.3 of the housing 1 through the material bonding connection 1.7 even at a pressure of up to 250 bar.

The housing body 1.0, 1.0′, 1.0″ is made of a mechanically resistant material such as metal, ceramic, etc. Preferably, said housing body 1.0 or the second housing body 1.0″ is made of material 1.3981 with a thermal expansion coefficient of less than or equal to 6.0 10⁻⁶ K⁻¹ in the range of from 20° C. to 450° C. Preferably, said first housing body 1.0′ is made of material 1.4548 with a thermal expansion coefficient of less than or equal to 13.0 10⁻⁶ K⁻¹ in the range of from 20° C. to 450° C. Preferably, said housing body 1.0 or said second housing body 1.0″ is made of aluminum oxide (Al₂O₃), zirconium silicate, aluminum nitride (AlN), silicon nitride (Si₃N₄), etc. with a thermal expansion coefficient of less than or equal to 7.0 10⁻⁶ K⁻¹ in the range of from 20° C. to 450° C. With knowledge of the present invention, the skilled artisan may also use another mechanically resistant material with a coefficient of thermal expansion of less than or equal to 7 10⁻⁶ K⁻¹ in the range of from 20° C. to 450° C. for the housing body 1.0 or the second housing body 1.0″.

### Base Body 2

The base body 2 is arranged in the interior 1.3. Said base body 2 has the function of receiving the pressure P of the medium M to be measured.

Said base body 2 comprises at least one of the following electrically insulating materials: silicon, silicon oxide, borosilicate glass, or silicon carbide. Monocrystal made of silicon exhibits a specific electrical resistance greater than or equal to 107 ohm meters (Ωm) at 20° C. Silicon exhibits a thermal expansion coefficient of 2.6 10⁻⁶ K⁻¹ at 20° C., which rises to 4.2 10⁻⁶ K⁻¹ at 450° C. Silicon oxide exhibits a specific electrical resistance greater than or equal to 10¹² Ωm at 20° C. Silicon oxide exhibits a thermal expansion coefficient of 4.5 10⁻⁷ K⁻¹ to 6.5 10⁻⁷ K⁻¹ in the range of from 20° C. to 450° C. Borosilicate glass exhibits a specific electrical resistance greater than or equal to 10⁸ Ωm at 20° C. Borosilicate glass exhibits a thermal expansion coefficient of 3.3 10⁻⁶ K⁻¹ +/−0.3 10⁻⁶ K⁻¹ in the range of from 20° C. to 450° C. Silicon carbide exhibits a specific electrical resistance greater than or equal to 10⁶ Ωm at 20° C. Silicon carbide exhibits a thermal expansion coefficient of 4.5 10⁻⁶ K⁻¹ in the range of from 20° C. to 450° C. With knowledge of the present invention, a person skilled in the art may also use a different electrically insulating material with an electrical resistance greater than or equal to 10⁷ Ωm and a thermal expansion coefficient of 4.5 10⁻⁷ K⁻¹ to 4.5 10⁻⁶ K⁻¹ in the range of from 20° C. to 450° C., such as silicon nitride, etc.

Said base body 2 is rectangular when viewed in the cross-sectional depictions of FIGS. 1 and 2. In certain areas of FIGS. 1 and 2, the base body 2 defines a blind hole 2.4 and a diaphragm 2.5. The blind hole 2.4 is arranged on a rear side of the base body 2 facing away from the horizontal plane XY shown in FIGS. 1 and 2. The blind hole 2.4 is defined to extend through at least a portion of the base body 2 and formed about the vertical ais z. Said diaphragm 2.5 is arranged on a front side of the base body 2 facing the horizontal plane XY and configured to cover, i.e., close off, the blind end of the blind hole 2.4. The open end of the blind hole 2.4 is configured and disposed so as to communicate with the opening 1.4 of the housing 1.

Preferably, said base body 2 is constructed using silicon-on-insulator (SOI) technology and comprises the following functional layers, namely, a supporting layer 2.1, a molding layer 2.2 and an oxide layer 2.3.

The supporting layer 2.1 consists of one of the following electrically insulating materials: silicon, borosilicate glass, or silicon carbide. Said supporting layer 2.1 exhibits a thickness in the range of 200 to 1200 μm along the vertical axis Z, preferably a thickness of 500 μm. Preferably, said supporting layer 2.1 is made of borosilicate glass or silicon monocrystal. The supporting layer 2.1 has the function of supporting the measuring unit 3 and mechanically decoupling the measuring unit 3 from housing 1. Said supporting layer 2.1 is rectangular with a first supporting front face 2.11 and a second supporting front face 2.12. The two supporting front faces 2.11, 2.12 extend in a perpendicular manner to the vertical axis Z. The blind hole 2.4 is formed as a through hole 2.13 in said supporting layer 2.1. Said through hole 2.13 extends along the vertical axis Z from the first supporting front face 2.11 to the second supporting front face 2.12. Said supporting layer 2.1 thus comprises the through hole 2.13 in the region of the first supporting end face 2.11. And the supporting layer 2.1 comprises the through hole 2.13 in the area of the second supporting front face 2.12. Along the vertical axis Z, the opening 1.4 communicates with the through hole 2.13.

The molding layer 2.2 consists of silicon and exhibits a thickness in the range of 40 μm to 1000 μm along the vertical axis Z, preferably it exhibits a thickness in the range of from 300 μm to 400 μm. Said molding layer 2.2 has the function of forming the diaphragm 2.5 in certain areas. Said molding layer 2.2 is rectangular with a first molding front face 2.21 and a second molding front face 2.22. The two molding front faces 2.21, 2.22 extend in a manner perpendicular to the vertical axis Z. In the molding layer 2.2, said blind hole 2.4 is formed as a trough-shaped recess 2.23. The trough-shaped recess 2.23 comprises sloping walls with respect to the vertical axis Z. The region of the molding layer 2.2 along the vertical axis Z between the trough-shaped recess 2.23 and the second molding front face 2.22 forms the diaphragm 2.5. The second supporting front face 2.12 and the first molding front face 2.21 are in direct contact in a plane perpendicular to the vertical axis Z. Preferably, supporting layer 2.1 and molding layer 2.2 are connected to each other in this contact plane via a connection 2.6 in mechanically tight manner. The connection 2.6 can be an electrochemical connection such as anodic bonding, etc., or a chemical connection such as direct bonding, etc. In the context of the invention, the term “mechanically tight” means that the connection remains functionally stable over the entire service life of the piezoresistive pressure sensor 10, which is at least ten years.

The oxide layer 2.3 consists of silicon oxide. Said oxide layer 2.3 has the function of electrically insulating the measuring unit 3, which is arranged in the horizontal plane XY, from the base body 2. Said oxide layer 2.3 is arranged on the second molding front face 2.22. The oxide layer 2.3 exhibits a thickness of less than or equal to 5 μm along the vertical axis Z. The oxide layer 2.3 has a specific electrical resistance of greater than or equal to 10¹² Ωm at 20° C. The oxide layer 2.3 confines said base body 2 in the horizontal plane XY.

The supporting layer 2.1 is connected to the housing 1 via said material bonding connection 4 in a mechanically tight manner. For a one-component housing 1 comprising a housing body 1.0 or for a multi-component housing 1 comprising a second housing body 1.0″, said supporting layer 2.1 is connected to the housing body 1.0 or the second housing body 1.0″ via the material bonding connection 4 in a mechanically tight manner. For the housing body 1.0 or the second housing body 1.0″ made of material 1.3981 and for the supporting layer 2.1 made of one of the following electrically insulating materials: silicon, borosilicate glass, or silicon carbide, a difference in the thermal expansion coefficients of the housing body 1.0 or the second housing body 1.0″ and the supporting layer 2.1 of less than or equal to 3.0 10⁻⁶ K⁻¹, preferably less than or equal to 2.0 10⁻⁶ K⁻¹ in the range of from 200° C. to 450° C. results in the material bonding connection 4. As a consequence, this difference in the coefficients of thermal expansion is so small that only minor mechanical stresses occur, which can lead to cracks or breakage in the supporting layer 2.1 or in the material bonding connection 4. Advantageously, this small difference in the thermal expansion coefficients also reduces the mechanical stress transfer to the measuring unit 3.

According to FIG. 1, blind hole 2.4 thus extends along the vertical axis Z via through hole 2.13 of said supporting layer 2.1 and the recess of the molding layer 2.2 and reaches as far as diaphragm 2.5. In a plane perpendicular to the vertical axis Z, said blind hole 2.4 has a diameter. The diameter of the blind hole 2.4 is less than or equal to 1000 μm, preferably less than or equal to 500 μm.

The base body 2 is arranged in the interior 1.3 in such a manner that said blind hole 2.4 communicates with the opening 1.4 and that said medium M from the environment E passes through the opening 1.4 into the blind hole 2.4 and from there to said diaphragm 2.5. Preferably, the blind hole 2.4 and the opening 1.4 are arranged in alignment with each other along the vertical axis Z. The pressure P to be measured is applied to said diaphragm 2.5. The pressure P to be measured is schematically shown as a black arrow in FIG. 1.

Said diaphragm 2.5 is designed to absorb the pressure P to be measured. The diaphragm 2.5 comprises a first surface and a second surface. The first surface faces the blind hole 2.4 and confines the blind hole 2.4 on one side. The second surface faces away from blind hole 2.4 and is covered with oxide layer 2.3. Diaphragm 2.5 absorbs the pressure P to be measured via the first surface. Under the effect of pressure P, diaphragm 2.5 can be deflected along the vertical axis Z.

Along vertical axis Z, said diaphragm 2.5 exhibits a thickness of less than or equal to 400 μm, preferably less than or equal to 100 μm, preferably less than or equal to 40 μm. In the horizontal plane XY, said diaphragm 2.5 has a diameter of less than or equal to 1500 μm, preferably less than or equal to 1000 μm.

### Measuring Unit 3

The measuring unit 3 is configured and disposed with the capability to perform the function of generating a change in resistance ΔR for the deflection of the diaphragm 2.4.

Said measuring unit 3 is arranged in the horizontal plane XY. Preferably, the measuring unit 3 is arranged on the oxide layer 2.3 of the second surface of the diaphragm 2.5. As a result, the measuring unit 3 is not directly exposed to the medium M. Therefore, the medium M can also be chemically aggressive, such as fuel for internal combustion engines, which would corrode the measuring unit 3 if it was directly exposed to the fuel and would undesirably shorten the service life of the piezoresistive pressure sensor 10. Furthermore, said measuring unit 3 is electrically insulated from the base body 2 by its arrangement on the oxide layer 2.3. Thus, the oxide layer 2.3 prevents leakage currents from the measuring unit 3 to said supporting layer 2.1 and enables the piezoresistive pressure sensor 10 to be used at continuous operating temperatures of up to 450° C.

The measuring unit 3 comprises a plurality of resistive elements made of piezoresistive material like boron-doped silicon, etc. The resistive elements are applied on the oxide layer 2.3 and are electrically insulated from each other by said oxide layer 2.3. The resistive elements are structured in height, length, and width. The resistive elements are connected by conductive elements to form a Wheatstone bridge circuit. As well, the conductive elements are applied to the oxide layer 2.3. The conductive elements are made of electrically conductive material such as highly doped silicon, aluminum, titanium, tungsten, etc. For connection to the Wheatstone bridge circuit, said conductive elements are structured in height, length, and width. The measuring unit 3 is schematically shown in FIG. 2 as a full bridge with four resistive elements. The resistive elements and conductive elements are applied and structured on the oxide layer 2.3 by means of chemical vapor deposition, physical vapor deposition, epitaxy, lithography, etching, etc. Preferably, each resistive element exhibits a height of less than or equal to 200 μm, a length of less than or equal to 500 μm, and a width of less than or equal to 50 μm. The deflection of the diaphragm 2.5 generates a change in resistance ΔR. The change in resistance ΔR is proportional to the pressure P to be measured.

### Electrical Conductor 5

The piezoresistive pressure sensor 10 comprises at least one electrical conductor 5. The electrical conductor 5 has the function of applying an electrical current I to the measuring unit 3 and tapping an electrical voltage U from the measuring unit 3 and discharging it into the environment E.

The electrical conductor 5 comprises several conductor paths 5.1, 5.1′, 5.1″, 5.1′″ and several contact points 5.2, 5.2′, 5.2″, 5.2′″. The conductor paths 5.1, 5.1′, 5.1″, 5.1′″ and the contact points 5.2, 5.2′, 5.2″, 5.2′″ are arranged on the oxide layer 2.3. The conductor paths 5.1, 5.1′, 5.1″, 5.1′″ and the contact points 5.2, 5.2′, 5.2″, 5.2′″ are made of electrically conductive material such as highly doped silicon, aluminum, titanium, tungsten, platinum, gold, etc. Preferably, the conductor paths 5.1, 5.1′, 5.1″, 5.1′″ have a height of less than or equal to 10 μm along the vertical axis Z and a width of less than or equal to 100 μm in the horizontal plane. Preferably, the contact points 5.2, 5.2′, 5.2″, 5.2′″ have a height of less than or equal to 10 μm along the vertical axis Z and an area of less than or equal to 1 mm² in the horizontal plane XY.

Preferably, said electrical conductor 5 comprises four conductor paths 5.1, 5.1′, 5.1″, 5.1′″ and four contact points 5.2, 5.2′, 5.2″, 5.2′″. Each of the four conductor paths 5.1, 5.1′, 5.1″, 5.1′″ comprises a first end and a second end. Each of the four conductor paths 5.1, 5.1′, 5.1″, 5.1′″ contacts the measuring unit 3 with its first end. Each of the four conductor paths 5.1, 5.1′, 5.1″, 5.1′″ contacts another location between two adjacent resistive elements of the measuring unit 3 with its first end. Each of the four conductor paths 5.1, 5.1′, 5.1″, 5.1′″ contacts a contact point 5.2, 5.2′, 5.2″, 5.2′″ with its second end. Each of the four conductor paths 5.1, 5.1′, 5.1″, 5.1′″ contacts another one of the four contact points 5.2, 5.2′, 5.2″, 5.2′″ with its second end. The contacts are electrical contacts.

The four conductor paths 5.1, 5.1′, 5.1″, 5.1′″ comprise two first conductor paths 5.1, 5.1′ and two second conductor paths 5.1″, 5.1′″. The four contact points 5.2, 5.2′, 5.2″, 5.2′″ comprise two first contact points 5.2, 5.2′ and two second contact points 5.2″, 5.2′″. The first conductor paths 5.1, 5.1′ and the second conductor paths 5.1″, 5.1′″ alternately contact the measuring unit 3. An electric current I is applied to the measuring unit 3 via the two first conductor paths 5.1, 5.1′ and the two first contact points 5.2, 5.2′. Preferably, the electric current I is constant at 1 mA. According to Ohm's law, a change in resistance ΔR of the measuring unit 3 and the applied electric current I results in an electric voltage U. The electric voltage U is tapped via the two second conductor paths 5.1″, 5.1′″ and the two second contact points 5.2″, 5.2′″.

Preferably, at least one passivation layer 2.3′ is applied to said measuring unit 3, the conductor paths 5.1, 5.1′, 5.1″, 5.1′″, and in some areas also to the oxide layer 2.3. The passivation layer 2.3′ protects the measuring unit 3 and the conductor paths 5.1, 5.1′, 5.1″, 5.1′″ against mechanical shocks, chemically reactive environmental influences such as oxygen, etc., and is suitable for forming a mechanical connection with the cover 6 described below. The passivation layer 2.3′ preferably consists of electrically insulating material such as silicon oxide, silicon nitride, etc. The passivation layer 2.3′ exhibits a thickness of less than or equal to 5 μm along the vertical axis Z. The passivation layer 2.3′ is also applied to said measuring unit 3, the conductor paths 5.1, 5.1′, 5.1″, 5.1′″, and the oxide layer 2.3 by means of chemical vapor deposition, physical vapor deposition, etc.

The electrical conductor 5 comprises several conductor wires 5.3, 5.3′, 5.3″, 5.3′″. The conductor wires 5.3, 5.3′, 5.3″, 5.3′″ are made of electrically conductive material such as aluminum, gold, etc. The conductor wires 5.3, 5.3′, 5.3″, 5.3′″ have diameters in the range of from 15 μm to 200 μm.

The conductor wires 5.3, 5.3′, 5.3″, 5.3′″ are connected to the contact points 5.2, 5.2′, 5.2″, 5.2′″ by means of thermosonic ball wedge bonding, ultrasonic wedge bonding, etc.

Preferably, the electrical conductor 5 comprises four conductor wires 5.3, 5.3′, 5.3″, 5.13′″. The four conductor wires 5.3, 5.3′, 5.3″, 5.13′″ comprise two first conductor wires 5.3, 5.3′ and two second conductor wires 5.3″, 5.3′″. The electrical current I is supplied from the environment E via the two first conductor wires 5.3, 5.3′. The electrical voltage U is discharged into the environment E via said two second conductor wires 5.3″, 5.3′″, the electrical voltage U is discharged into the environment E. The conductor wires 5.3, 5.3′, 5.3″, 5.3′″ leave the interior 1.3 of the housing 1 via an electrical feed-through of the housing 1, which is not shown in the figure.

### Cover 6

The piezoresistive pressure sensor 10 comprises at least one cover 6. Said cover 6 has the function of forming a reference pressure P′ for said measuring unit 3.

Cover 6 is arranged in horizontal plane XY as schematically shown in FIGS. 1-3. Said cover 6 is arranged on the oxide layer 2.3. Preferably, the cover 6 is also arranged in areas on the conductor paths 5.1, 5.1′, 5.1″, 5.1′″. In case there is a passivation layer 2.3′ on the measuring unit 3, the conductor paths 5.1, 5.1′, 5.1″, 5.1′″, and the oxide layer 2.3, said cover 6 is arranged in areas on the passivation layer 2.3′.

Said cover 6 is made of borosilicate glass or silicon. Preferably, the cover 6 is rectangular in shape and has side lengths. Preferably, the cover 6 has a height in the range of 100 to 800 μm, preferably 500 μm, along the vertical axis Z, and in the horizontal plane XY it has a side length of less than or equal to 2000 μm, preferably less than or equal to 1200 μm.

With knowledge of the present invention, a person skilled in the art can also use a different electrically insulating material for the cover 6 with an electrical resistance greater than or equal to 10⁷ Ωm and a thermal expansion coefficient of 2.6 10⁻⁶ K⁻¹ to more than 4.2 10⁻⁶ K⁻¹ in the range of from 20° C. to 450° C.

Preferably, said cover 6 is pot-shaped comprising a cavity 6.2, which is enclosed by an edge area 6.1 which is radially spaced from the vertical axis Z. Said cover 6 placed on the oxide layer 2.3 or the passivation layer 2.3′ is designed to completely accommodate the measuring unit 3 in the cavity 6.2. For this purpose, the height and diameter of the cavity 6.2 are larger than the height and diameter of the measuring unit 3. The reference pressure P′ prevails in the cavity 6.2 of the cover 6. The cover 6 placed on the oxide layer 2.3 or the passivation layer 2.3′ is designed to maintain the reference pressure P′ in the cavity 6.2 constant over time. For this purpose, said cover 6 placed on the oxide layer 2.3 or the passivation layer 2.3′ is in direct contact with the oxide layer 2.3 or the passivation layer 2.3′ in the horizontal plane XY via the edge area 6.1. Preferably, the cover 6 and the oxide layer 2.3 or the passivation layer 2.3′ are connected to each other in this contact plane via a further connection 2.7 in a mechanically tight manner. The further connection 2.7 can be an electrochemical connection such as anodic bonding, etc., or a chemical connection such as direct bonding, etc. Said further connection 2.7 is pressure-tight in such a way that the reference pressure P′ in the cavity remains constant during the average service life of the piezoresistive pressure sensor 10 of at least ten years.

Preferably, the contact plane of cover 6 and oxide layer 2.3 or passivation layer 2.3′lies within the contact points 5.2, 5.2′, 5.2″, 5.2′″ in a radial manner with respect to the vertical axis Z. The contact points 5.2, 5.2′, 5.2″, 5.2′″ are thus located outside the cavity 6.2. This means that the electrical contact between the conductor wires 5.3, 5.3′, 5.3″, 5.3′″ is not constricted by cover 6.

Preferably, the contact plane of cover 6 and oxide layer 2.3 or passivation layer 2.3′ lies outside said diaphragm 2.5 in a radial manner with respect to the vertical axis Z. As a result, the mechanical connection of cover 6 to oxide layer 2.3 or passivation layer 2.3′ has no influence on the deflection of diaphragm 2.5 under the effect of pressure P, and the measurement of pressure P is not influenced by cover 6.

The reference pressure P′ is less than or equal to 10⁻³ bar. The reference pressure is thus more than three orders of magnitude smaller than the pressure P to be measured. The reference pressure P′ serves as a reference for measuring the pressure P. By using this reference, the piezoresistive pressure sensor 10 measures the pressure in an absolute manner.

### Material Bonding Connection 4

The piezoresistive pressure sensor 10 comprises at least one material bonding connection 4. Said material bonding connection 4 serves to connect the housing 1 to the base body 2 in a mechanically tight and pressure-tight manner.

The material bonding connection 4 can be formed in multiple ways, but in each of these ways, the material bonding connection desirably comprises at least two essential materials M1, M2 that become fused together to form the material bonding connection 4. The two essential materials M1, M2 comprise a first material M1 and a second material M2.

### Soldered Joint

In a first embodiment, said material bonding connection 4 is a soldered joint comprising a first material M1, which exhibits a higher melting point than the second material M2. Said first material M1 is one of the following metals: silver with a melting temperature of 962° C., gold with a melting temperature of 1064° C., copper with a melting temperature of 1085° C., or nickel with a melting temperature of 1455° C. Said second material M2 is one of the following metals: indium with a melting temperature of 157° C. or tin with a melting temperature of 232° C.

Preferably, said first material M1 is gold and the second material M2 is indium. Said material bonding connection 4 consisting of gold and indium then has a mass fraction of the first material M1 gold greater than or equal to 46%. Due to the mass fraction of the first material M1 gold being greater than or equal to 46%, said material bonding connection 4 exhibits a melting temperature TM greater than or equal to 250° C., preferably greater than or equal to 450° C.

Preferably, in another embodiment of the material bonding connection, said first material M1 is gold and the second material M2 is tin. Said material bonding connection 4 made of gold and tin then has a mass fraction of the first material M1 gold of greater than or equal to 80%, preferably greater than or equal to 89%, preferably greater than or equal to 93%. Due to the mass fraction of the first material M1 gold being greater than or equal to 80%, the material bonding connection 4 exhibits a melting temperature TM greater than or equal to 250° C., preferably greater than or equal to 278° C. With a mass fraction of the first material M1 gold being greater than or equal to 93%, the material bonding connection 4 exhibits a melting temperature TM greater than or equal to 522° C.

In a further embodiment, said material bonding connection 4 is a soldered joint comprising a first material M1, which is an electrical conductor, and a second material M2, which is an electrical semiconductor. Said first material M1 is one of the following electrical conductors: silver with a melting temperature of 962° C., gold with a melting temperature of 1064° C. Said second material M2 is one of the following electrical semiconductors: germanium with a melting temperature of 938° C. or silicon with a melting temperature of 1410° C.

Preferably, said first material M1 is gold and the second material M2 is germanium. The material bonding connection 4 made of gold and germanium then has a mass fraction of the first material M1 gold greater than or equal to 88%. Due to the mass fraction of the first material M1 gold being greater than or equal to 88%, said material bonding connection 4 exhibits a melting temperature TM greater than or equal to 250° C., preferably greater than or equal to 356° C.

Preferably, said first material M1 is gold and the second material M2 is silicon. The material bonding connection 4 consisting of gold and silicon then has a mass fraction of the first material M1 gold greater than or equal to 96%. Due to the mass fraction of the first material M1 gold being greater than or equal to 96%, the material bonding connection 4 exhibits a melting temperature TM greater than or equal to 250° C., preferably greater than or equal to 363° C.

For the first and second embodiments of said material bonding connection 4 as a soldered joint, the high mass fraction of the first material M1 gold in the material bonding connection 4 imparts high plastic deformability. Gold exhibits significantly greater plastic deformability than the second material M2, tin or germanium. Compared to tin or germanium, gold is significantly more ductile under tensile stress.

The high plastic deformability of the material bonding connection 4 as a soldered joint is significant. This is because mechanical stresses occur at high continuous operating temperatures of the piezoresistive pressure sensor 10 in the range of from 200° C. to 450° C. due to the difference in the thermal expansion coefficients of the housing 1 and the supporting layer 2.1. Although this difference in thermal expansion coefficients may be small due to the choice of material for said housing 1 and the electrically insulating material for said supporting layer 2.1, so that the magnitude of the mechanical stresses is also small, the high plastic deformability of the material bonding connection 4 further actively reduces these mechanical stresses. Due to its high plastic deformability, said material bonding connection 4 compensates for the different expansion of housing 1 and supporting layer 2.1. The active reduction of mechanical stresses reduces the probability of failure of the piezoresistive pressure sensor 10 due to cracks or breaks in the supporting layer 2.1 or in the material bonding connection 4. On the other hand, the active reduction of mechanical stresses improves the accuracy of the measurement of pressure P, because the mechanical stresses also affect the measuring unit 3 and cause a change in resistance there, which is not caused by the pressure P to be measured and thus distorts the measurement signal.

It applies for the first and second embodiments of said material bonding connection 4 as a soldered joint, that the high mass fraction of the first material M1 gold in the material bonding connection 4 confers high corrosion resistance. This enables that the piezoresistive pressure sensor 10 can be used in a chemically aggressive medium M such as fuel for internal combustion engines without impairing the material bonding connection 4 and thus the availability of the piezoresistive pressure sensor 10.

### Glass Solder

In a third embodiment, said material bonding connection 4 is a glass solder with a first material M1, which exhibits a higher melting point than the second material M2.

Preferably, said first material M1 of the glass solder is bismuth(III) oxide with a melting temperature of 817° C. and said second material M2 is boron trioxide with a melting temperature of 475° C. The material bonding connection 4 of bismuth(III) oxide and boron trioxide then has a mass fraction of the first material M1 bismuth(III) oxide of greater than or equal to 79% and less than or equal to 88%, and it has a mass fraction of the second material M2 boron trioxide of greater than equal to 5% and less than or equal to 10%. Due to the mass fraction of the first material M1 bismuth(III) oxide being greater than or equal to 79% and less than or equal to 88%, said material bonding connection 4 then exhibits a melting temperature TM of greater than or equal to 350° C.

Preferably, said first material M1 of another glass solder embodiment is lead(II) oxide with a melting temperature of 888° C. and said second material M2 is boron trioxide with a melting temperature of 475° C. Preferably, said material bonding connection 4 then exhibits a melting temperature TM greater than or equal to 350° C.

### Method for Manufacturing the Piezoresistive Pressure Sensor

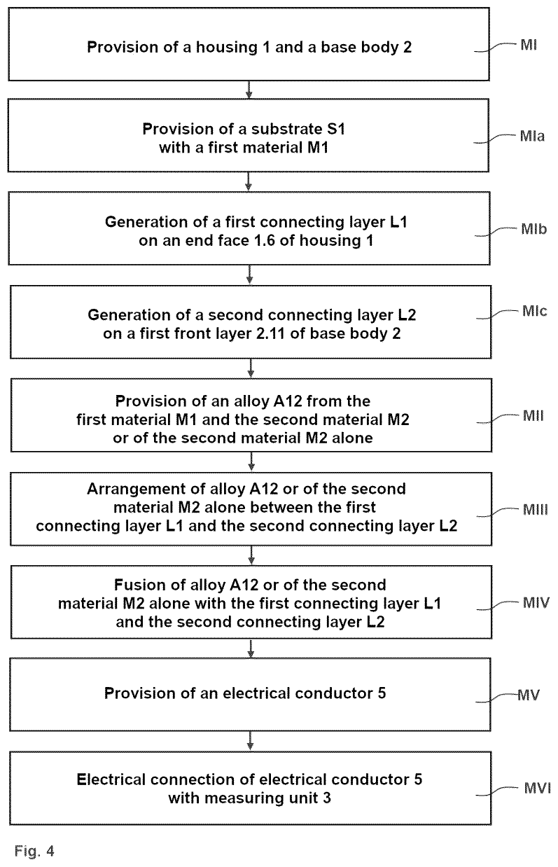

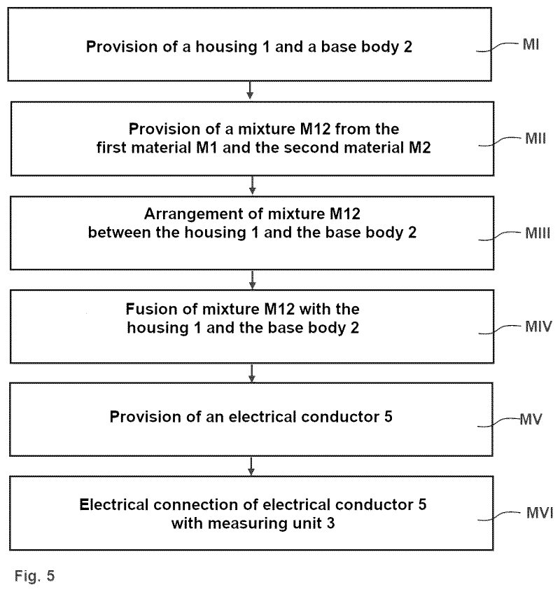

FIGS. 4 and 5 show steps MI to MVI in the method for manufacturing said piezoresistive pressure sensor 10. FIGS. 4 and 5 show two method variants. FIG. 4 shows a first method variant using the material bonding connection 4 in the embodiment of a soldered joint, and FIG. 5 shows a second method variant using the material bonding connection 4 in the embodiment of a glass solder.

Steps MI to MVI comprise a first step MI, further first steps MIa to MIc, and further steps MII to MVI, which are also referred to below as a further second step MII, a further third step MIII, a further fourth step MIV, a further fifth step MV, and a further sixth step MVI.

In both method variants according to FIGS. 4 and 5, the first step MI takes place. In the first step MI, the housing 1 and the base body 2 are provided. The base body 2 is made of electrically insulating material. The base body comprises the supporting layer 2.1.

Only in the first method variant according to FIG. 4 a substrate S1 with the first material M1 is provided in a further first step MIa. For example, when the first material M1 is gold, then a substrate S1 of gold is used to deposit gold as a first connecting layer L1 of gold on the end face 1.6 of housing 1 and on the supporting front face 2.11 of the base body 2 as a second connecting layer L2 of gold on the first supporting front face 2.11 of the base body 2.

Only in the first method variant according to FIG. 4, is the first material M1 deposited from the substrate S1 on the end face 1.6 of said housing 1 in a further first step MIb and a first connecting layer L1 is formed. The deposition of said first material M1 on the end face 1.6 of the housing 1 is carried out by means of chemical vapor deposition, physical vapor deposition, electroplating, etc. Along the vertical axis Z, the first connecting layer L1 exhibits a thickness of less than or equal to 20 μm, preferably less than or equal to 10 μm. Because FIGS. 1 and 2 are intended to show a manufactured sensor 10, the fusion of the two connecting layers L1 and L2 already has occurred to produce the material bonding connection 4 illustrated in FIGS. 1 and 2. This explains why the first connecting layer L1 is not separately illustrated in FIGS. 1 and 2.

Also only in the first method variant according to FIG. 4, in an additional further first step MIc, said first material M1 is deposited from the substrate S1 on the first supporting front face 2.11 and a second connecting layer L2 is formed. The deposition of the first material M1 on the first supporting front face 2.11 is carried out by means of chemical vapor deposition, physical vapor deposition, electroplating, etc. Along the vertical axis Z, said second connecting layer L2 exhibits a thickness of less than or equal to 20 μm, preferably less than or equal to 10 μm. As explained above, because FIGS. 1 and 2 are intended to show a manufactured sensor 10, the fusion of the two connecting layers L1 and L2 already has occurred to produce the material bonding connection 4 illustrated in FIGS. 1 and 2. This explains why the second connecting layer L2 is not separately illustrated in FIGS. 1 and 2.

In both method variants according to FIGS. 4 and 5, after the substrate S1 of the first material M1, which is an electrically conducting substance, is deposited to form a first connecting layer L1 on the end face 1.6 of housing 1 and deposited to form a second connecting layer L2 on the supporting front face 2.11 of the base body 2, then said further second step MII takes place.

In the first method variant according to FIG. 4, in a further second step MII, another constituent is disposed between the first connecting layer L1 and the second connecting layer L2. This intermediately disposed constituent is either a second material M2 or an alloy A12 that is provided as a combination of the first material M1 and the second material M2, and accordingly the alloy A12 is a macroscopically homogeneous metallic material.

In the second method variant according to FIG. 5, in a further second step MII, instead of the intermediately disposed constituent being an alloy A12 consisting of materials M1 and M2, the intermediately disposed constituent is provided as a mixture M12 of the first material M1 and the second material M2.

Alloy A12 or second material M2 alone, or mixture M12, can be provided in a variety of ways. For example, alloy A12 or second material M2 alone, or mixture M12, can be provided as a powder, as a full part, or as a molded part.

In both method variants according to FIGS. 4 and 5, the further third step MIII takes place.

In the first method variant according to FIG. 4, in the further third step MIII, alloy A12 or the second material M2 is arranged alone between the first connecting layer L1 and the second connecting layer L2. Said alloy A12 or said second material M2 can be placed between the first connecting layer L1 and the second connecting layer L2 by depositing the powder or the full part using chemical vapor deposition, physical vapor deposition, electroplating, etc., or it can be achieved by positioning the molded part between the first connecting layer L1 and the second connecting layer L2.

In the second method variant according to FIG. 5, in a further third step MIII, the mixture M12 is arranged between the housing 1 and the base body 2. Said mixture M12 can be placed between the housing 1 and the base body 2 by depositing the powder or the full part using chemical vapor deposition, physical vapor deposition, dispensing, screen printing, electroplating, etc., or it can be done by positioning the molded part between the housing 1 and the base body 2.

Along the vertical axis Z, alloy A12 or second material M2 alone or mixture M12 exhibits a thickness of less than or equal to 100 μm, preferably less than or equal to 50 μm, preferably less than or equal to 13 μm.

In both method variants according to FIGS. 4 and 5, the further fourth step MIV takes place.

In the first method variant according to FIG. 4, in the further fourth step MIV, which is a fusion step, said alloy A12 or said second material M2 arranged between first connecting layer L1 and second connecting layer L2 is fused with the first connecting layer L1 and the second connecting layer L2 alone by the application of heat, which desirably is performed after placing the components into an oven that furnishes the heat, normally under conditions of constant temperature and moderate pressure. The melting temperature of alloy A12 or the second material M2 alone is lower than the melting temperature TM of the material bonding connection 4. In the course of fusion, because the alloy A12 or the second material has a lower melting temperature than the first material M1, they will melt before the first material M1 and accordingly react with the first material M1, which diffuses from the two connecting layers L1, L2 into the alloy A12 or into the second material M2, while the second material M2 diffuses into the two connecting layers L1, L2. By fusing alloy A12 or the second material M2 alone with the first connecting layer L1 and the second connecting layer L2, the material bonding connection 4 is formed as a high-melting intermetallic compound in the embodiment of a soldered joint.

In alloy A12 or in the second material M2 alone, the mass fraction of the first material M1 is smaller than in the resulting material bonding connection 4. Due to the higher mass fraction of the first material M1, the melting temperature TM of the material bonding connection 4 is higher than the melting temperature of alloy A12 or the second material M2. As a result, the temperature load on the measuring unit 3 arranged on the base body 2 during fusion is significantly lower than with other equivalent methods, which improves the measuring properties of the piezoresistive pressure sensor 10 and reduces the probability of failure of the measuring unit 3 during manufacture.

In the second method variant according to FIG. 5, in a further fourth step MIV, which is a fusion step, said mixture M12 arranged between the housing 1 and the base body 2 is fused with the housing 1 and the base body 2 by the application of heat. When the mixture M12 is fused with the housing 1 and the base body 2, no diffusion of the materials M1 and M2 occurs. By fusion of the mixture M12 with the housing 1 and the base body 2, a material bonding connection 4 is formed in the embodiment of a glass solder.

In both method variants according to FIGS. 4 and 5, the electrical conductor 5 is provided in a further fifth step MV.

In both method variants according to FIGS. 4 and 5, in the further sixth step MVI, the electrical conductor 5 is electrically connected to the measuring unit 3, which electrical conductor 5 taps the change in resistance ΔR as electrical voltage U and discharges it into the environment E.

In an embodiment of a method of manufacturing a piezoresistive pressure sensor in which the base body 2 comprises a supporting layer 2.1, a blind hole 2.5 is formed as a through hole 2.13 in the supporting layer 2.1. The supporting layer 2.1 defines a first supporting front face 2.11 in the region of the through hole 2.13. In an additional further first step MIc of the method, a first material M1 is deposited from the substrate S1 on the first supporting front face 2.11, and a second connecting layer L2 is formed. The second connecting layer L2 is controlled to exhibit a thickness of less than or equal to 20 μm, and preferably a thickness of less than or equal to 10 μm.

In an embodiment of a method of manufacturing a piezoresistive pressure sensor, in a further second step MII of the method, an alloy A12 consisting of the first material M1 and a second material M2 or the second material M2 alone is provided, which alloy A12 or which second material M2 alone exhibits a thickness of less than or equal to 100 μm, preferably less than or equal to 50 μm, preferably less than or equal to 13 μm. In the further third step MIII of the method, the alloy A12 or the second material M2 alone is arranged between a first connecting layer L1 and a second connecting layer L2. In a further fourth step MIV of the method, under the application of heat, the alloy A12 or the second material M2 alone, which is arranged between the first connecting layer L1 and the second connecting layer L2, is fused with the first connecting layer L1 and the second connecting layer L2.

In an embodiment of a method of manufacturing a piezoresistive pressure sensor, fusion of the alloy A12 or the second material M2 alone with the first connecting layer L1 and the second connecting layer L2 is what forms the said material bonding connection 4, which desirably is formed as a soldered joint with a melting temperature greater than the melting temperature of the alloy A12 or the second material M2 alone.

In an embodiment of a method of manufacturing a piezoresistive pressure sensor, in a further second step MII, a mixture M12 of the first material M1 and a second material M2 is provided so that the mixture M1 exhibits a thickness of less than or equal to 100 μm, preferably less than or equal to 50 μm, preferably less than or equal to 13 μm. In the further third step MIII of the method, said mixture M12 is arranged between the housing 1 and the base body 2. In a further fourth step MIV of the method, said mixture M12 is arranged to be fused between the housing 1 and the base body 2 by the application of heat. In this way, the fusion of the mixture M12 with the first connecting layer L1 of the housing 1 and the second connecting layer L2 of the base body 2 forms the material bonding connection 4, which is a glass solder.

### LIST OF REFERENCE SYMBOLS

10 Piezoresistive pressure sensor
1 Housing
1.0-1.0″ Housing body
1.1 Front face
1.2 Lateral surface 1.3 Interior
1.4 Opening
1.5 Mounting means
1.6 End face
1.7 Material bonding connection
2 Base body
2.1 Supporting layer
2.11 First supporting front face
2.12 Second supporting front face
2.13 Through hole
2.2 Molding layer
2.21 First molding front face
2.22 Second molding front face
2.23 Trough-shaped recess
2.3 Oxide layer
2.3′ Passivation layer
2.4 Blind hole
2.5 Diaphragm
2.6 Connection
2.7 Further connection
3 Measuring unit
4 Material bonding connection
5 Electrical conductor
5.1-5.1′″ Conductor path
5.2-5.2′″ Contact point
5.3, 5.3′ Conductor wire
6 Cover
6.1 Edge area
6.2 Cavity
A-A Section pathway
A12 Alloy
E Environment
I Electrical current
L1, L2 Connecting layer
M Medium
M1, M2 Material
M12 Mixture
MI-MVI Steps of the method
P Pressure
P′ Reference pressure
ΔR Change in resistance
S1 Substrate
TM Melting temperature
U Electrical voltage
X Horizontal axis
XY Horizontal plane
Y Longitudinal axis
Z Vertical axis

What is claimed is:

1. Piezoresistive pressure sensor for measuring the pressure of a medium in an environment, the piezoresistive pressure sensor comprising:
a housing that defines an interior and an opening extending through a first end of the housing and formed about a first axis, wherein the housing is configured to expose the opening to the environment;
a base body defining a blind hole extending through the base body and formed about the first axis;
a diaphragm that covers the blind hole at a first end of the blind hole, wherein the base body is disposed in the interior of the housing in such a way that the blind hole communicates with the opening to define an open pathway along the first axis to the diaphragm;
a measuring unit disposed in the interior of the housing on a side of the diaphragm facing away from the blind hole, wherein the measuring unit is configured to generate a change in resistance commensurate with a deflection of the diaphragm in the direction of the first axis, which change in resistance is proportional to the pressure to be measured; and
a material bonding connection, which includes an electrically conducting composite material and connects the base body directly to the housing in a mechanically tight manner and exhibits a melting temperature greater than or equal to 250° C.

2. Piezoresistive pressure sensor according to claim 1, further comprising an electrical conductor connected to the measuring unit and configured to tap the change in resistance as electrical voltage and discharge the electrical voltage into the environment.

3. Piezoresistive pressure sensor according to claim 1, wherein the material bonding connection is a soldered joint of at least a first material and a second material; wherein the first material exhibits a higher melting point than the second material; wherein the first material is one of the following metals: silver, gold, copper, and nickel; and wherein said second material is one of the following metals: indium and tin.

4. Piezoresistive pressure sensor according to claim 3, wherein the first material is gold; wherein the second material is indium; wherein the mass fraction of the first material gold is greater than or equal to 46%; and wherein the material bonding connection exhibits a melting temperature greater than or equal to 450° C.

5. Piezoresistive pressure sensor according to claim 3, wherein the first material is gold; wherein the second material is tin; wherein the mass fraction of the first material gold is greater than or equal to 80%; and wherein the material bonding connection exhibits a melting temperature greater than or equal to 278° C.

6. Piezoresistive pressure sensor according to claim 3, wherein the first material is gold; wherein the second material is tin; wherein the mass fraction of the first material gold is greater than or equal to 93%; and wherein the material bonding connection exhibits a melting temperature greater than or equal to 522° C.

7. Piezoresistive pressure sensor according to claim 1, wherein the material bonding connection is a soldered joint made of at least a first material and a second material; wherein the first material is an electrical conductor and the second material is an electrical semiconductor; wherein the first material is one of the following metals: silver and gold; and wherein the second material is one of the following semiconductors: germanium and silicon.

8. Piezoresistive pressure sensor according to claim 7, wherein the first material is gold; wherein the second material is germanium; wherein the mass fraction of the first material gold is greater than or equal to 88%; and wherein the material bonding connection exhibits a melting temperature greater than or equal to 356° C.

9. Piezoresistive pressure sensor according to claim 7, wherein the first material is gold; wherein the second material is silicon; wherein the mass fraction of the first material gold is greater than or equal to 96%; and wherein the material bonding connection exhibits a melting temperature greater than or equal to 363° C.

10. Piezoresistive pressure sensor according to claim 1, wherein the material bonding connection is a glass solder comprising at least a first material and a second material; wherein the first material exhibits a higher melting point than the second material; wherein the first material is bismuth(III) oxide or lead(II) oxide and the second material is boron trioxide; and wherein the material bonding connection exhibits a melting temperature greater than or equal to 350° C.

11. Piezoresistive pressure sensor according to claim 1, wherein the first end of the housing forms an end face partially defining the interior in a region of the opening; wherein the base body includes a supporting layer through which the blind hole is formed as a through hole; wherein the supporting layer defines a first supporting front face in a region of the through hole; and wherein the base body is arranged in the interior in such a way that the first supporting front face is connected to the end face via said material bonding connection in a mechanically tight manner and the opening communicates with the through hole along the axis.

12. Piezoresistive pressure sensor according to claim 11, wherein the base body includes a molding layer that carries the diaphragm in such a way as to define the blind hole to define a trough-shaped recess; wherein the molding layer defines a first molding front face and a second molding front face; and wherein a region of the molding layer in the vicinity of the axis between the trough-shaped recess and the second molding front face forms the diaphragm.

13. Piezoresistive pressure sensor according to claim 12, wherein the second supporting front face and the first molding front face are in direct contact and form a contact plane in which the supporting layer and the molding layer are connected to each other via a connection in a mechanically tight manner.

14. Piezoresistive pressure sensor according to claim 11, wherein the base body includes an oxide layer disposed on the second molding front face; and wherein the measuring unit is disposed on the oxide layer and includes a plurality of resistive elements made of piezoresistive material.

15. Piezoresistive pressure sensor according to claim 14, further comprising a cover that is pot-shaped and defines a cavity surrounded by an edge area; and
wherein the cover is disposed on the oxide layer with the edge area completely accommodating the measuring unit in said cavity so as to maintain a reference pressure constant over time in the cavity to enable measurement of a pressure in an absolute manner by reference to the reference pressure.

16. Piezoresistive pressure sensor according to claim 11, wherein the housing includes a first housing body and a second housing body; wherein the supporting layer is connected to the second housing body via the material bonding connection in a mechanically tight manner; wherein the second housing body is made of a mechanically resistant material that exhibits a thermal expansion coefficient of less than or equal to 7.0 10⁻⁶ K⁻¹ in the range of from 20° C. to 450° C.; wherein the supporting layer is made of an electrically insulating material that exhibits a thermal expansion coefficient of less than or equal to 4.5 10⁻⁶ K⁻¹ in the range of from 20° C. to 450° C.; and wherein the thermal expansion coefficients of the second housing body and the supporting layer differ by less than or equal to 2.0 10⁻⁶ K⁻¹, in the range of from 20° C. to 450° C.

17. Piezoresistive pressure sensor according to claim 14, further comprising: a passivation layer applied to the oxide layer; a cover that is pot-shaped and defines a cavity surrounded by an edge area; and wherein the cover is disposed on the passivation layer with the edge area completely accommodating the measuring unit in said cavity so as to maintain a reference pressure constant over time in the cavity to enable measurement of a pressure in an absolute manner by reference to the reference pressure.

18. Method for manufacturing a piezoresistive pressure sensor for measuring the pressure of a medium in an environment; the method comprising the following steps:
in a housing defining an interior and an opening into the interior, disposing a base body in the interior, wherein the base body defines a blind hole and a diaphragm, which confines said blind hole on one side of the blind hole;
disposing a measuring unit in the interior;
arranging the base body in the interior in such a manner that said blind hole communicates with the opening in such a manner that when the piezoresistive pressure sensor is exposed to the medium, then the medium is free to penetrate through the opening and the blind hole to the diaphragm, which pressure of the medium that has penetrated to the diaphragm deflects the diaphragm;
arranging the measuring unit on a side of the diaphragm facing away from the blind hole so as to generate a change in resistance for the deflection of the diaphragm, which change in resistance is proportional to the pressure to be measured;
directly connecting the base body to the housing via at least one material bonding connection in a mechanically tight manner, which material bonding connection exhibits a melting temperature greater than or equal to 250° C.

19. Method according to claim 18, further comprising: electrically connecting an electrical conductor to the measuring unit, which electrical conductor is configured to tap the change in resistance as an electrical voltage and to discharge the electrical voltage into the environment.

20. Method according to claim 18, further comprising: first step of the method, a substrate comprising a first material is provided; that said housing forms an end face towards the interior in the area of the opening; that in yet another first step of the method, said first material is deposited from the substrate on the end face and a first connecting layer is formed, which first connecting layer exhibits a thickness of less than or equal to 10 μm.
